(19) United States
(12) Patent Application Publication
(10) Pub. No.: US 2019/0291004 A1
(43) Pub. Date: Sep. 26, 2019

(54) ACTIVITY SEARCH METHOD AND APPARATUS

(71) Applicant: Sony Interactive Entertainment Inc., Tokyo (JP)

(72) Inventors: Hogarth Andall, London (GB); Stephen Anthony Hack, London (GB)

(73) Assignee: Sony Interactive Entertainment Inc., Tokyo (JP)

(21) Appl. No.: 16/355,931

(22) Filed: Mar. 18, 2019

(30) Foreign Application Priority Data
Mar. 21, 2018 (GB) 1804476.8

(51) Int. Cl. A63F 13/44; A63F 13/46; A63F 13/798

(52) U.S. Cl. CPC A63F 13/44; A63F 13/798; A63F 13/46

(57) ABSTRACT

A method of searching for videogame activities comprises receiving a request comprising a target time for a first player within which to complete an in game activity, accessing a record of the current game state for one or more games playable by the first player, obtaining timing data for elapsed times between validated pairs of game states that includes an accessed current game state and a candidate next game state, and selecting one or more of the plurality of candidate next game states playable by the first player, responsive to the target time and the obtained timing data.

### BACKGROUND OF THE INVENTION

### Field of the Invention

The present invention relates to an activity search method and apparatus.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Video games are played by people across all demographics, and consequently are played by people with many different lifestyles. For example, some people may be able to devote an entire day to playing a game, whilst others may sometimes only be able to fit in a short period of time in which to play.

Nevertheless people with limited available time will still wish to have a fulfilling gaming experience, across a broad range of games.

The present invention aims to address or mitigate this problem.

### SUMMARY OF THE INVENTION

In a first aspect, a method of searching for videogame activities is provided in accordance with claim 1.

In another aspect, a videogame activity search apparatus is provided in accordance with claim 13.

Further respective aspects and features of the invention are defined in the appended claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a videogame activity search apparatus in accordance with embodiments of the present invention.

FIG. 2 is a flow diagram of a method of searching for videogame activities in accordance with embodiments of the present invention.

FIG. 3 is a schematic diagram of a timing histogram in accordance with embodiments of the present invention.

### DESCRIPTION OF THE EMBODIMENTS

An activity search method and apparatus are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

A videogame activity search apparatus may take the form of a user's videogame console device for hosting playable videogames, a server operable to communicate with such a user's videogame console via a network, or a combination of the two.

Hence for the purposes of explanation a videogame activity search apparatus may take the form of a Sony® PlayStation 4® entertainment device, operating under suitable software instruction.

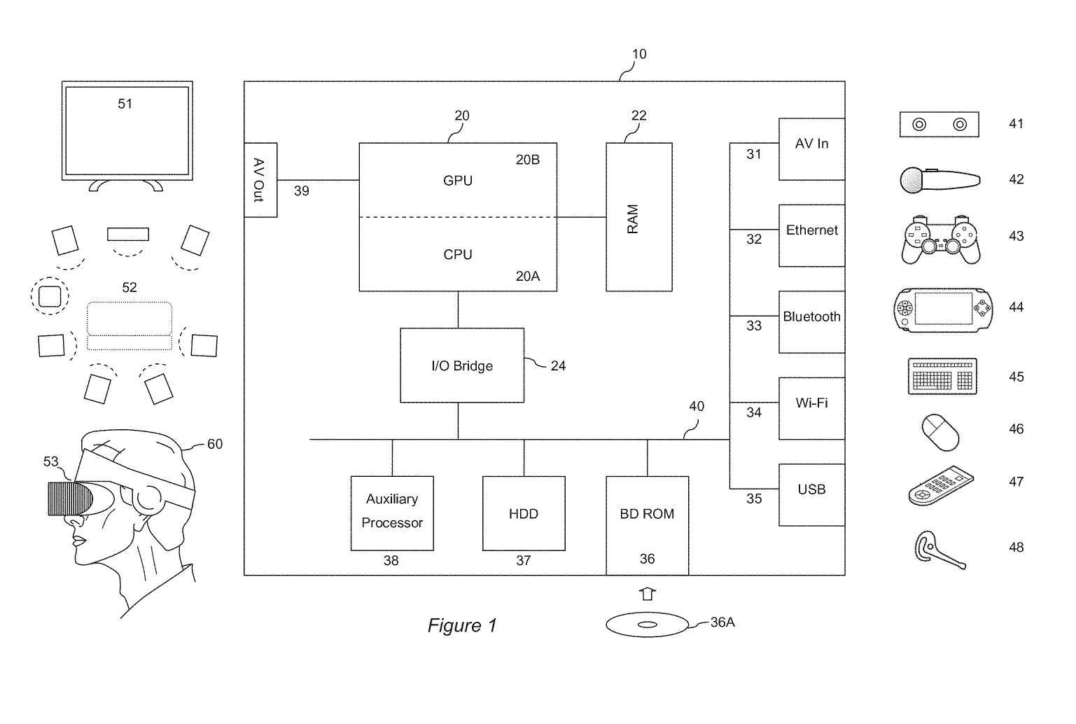

Referring now to the drawings, wherein like reference numerals designate identical or corresponding parts throughout the several views, FIG. 1 schematically illustrates the overall system architecture of the Sony® PlayStation 4® entertainment device. A system unit 10 is provided, with various peripheral devices connectable to the system unit.

The system unit 10 comprises an accelerated processing unit (APU) 20 being a single chip that in turn comprises a central processing unit (CPU) 20A and a graphics processing unit (GPU) 20B. The APU 20 has access to a random access memory (RAM) unit 22.

The APU 20 communicates with a bus 40, optionally via an I/O bridge 24, which may be a discreet component or part of the APU 20.

Connected to the bus 40 are data storage components such as a hard disk drive 37, and a Blu-ray® drive 36 operable to access data on compatible optical discs 36A. Additionally the RAM unit 22 may communicate with the bus 40.

Optionally also connected to the bus 40 is an auxiliary processor 38. The auxiliary processor 38 may be provided to run or support the operating system.

The system unit 10 communicates with peripheral devices as appropriate via an audio/visual input port 31, an Ethernet® port 32, a Bluetooth® wireless link 33, a Wi-Fi® wireless link 34, or one or more universal serial bus (USB) ports 35. Audio and video may be output via an AV output 39, such as an HDMI port.

The peripheral devices may include a monoscopic or stereoscopic video camera 41 such as the PlayStation Eye®; wand-style videogame controllers 42 such as the PlayStation Move® and conventional handheld videogame controllers 43 such as the DualShock 4®; portable entertainment devices 44 such as the PlayStation Portable® and PlayStation Vita®; a keyboard 45 and/or a mouse 46; a media controller 47, for example in the form of a remote control; and a headset 48. Other peripheral devices may similarly be considered such as a printer, or a 3D printer (not shown).

The GPU 20B, optionally in conjunction with the CPU 20A, generates video images and audio for output via the AV output 39. Optionally the audio may be generated in conjunction with or instead by an audio processor (not shown).

The video and optionally the audio may be presented to a television 51. Where supported by the television, the video may be stereoscopic. The audio may be presented to a home cinema system 52 in one of a number of formats such as stereo, 5.1 surround sound or 7.1 surround sound. Video and audio may likewise be presented to a head mounted display unit 53 worn by a user 60.

In operation, the entertainment device defaults to an operating system such as a variant of FreeBSD 9.0. The operating system may run on the CPU 20A, the auxiliary processor 38, or a mixture of the two. The operating system provides the user with a graphical user interface such as the PlayStation Dynamic Menu. The menu allows the user to access operating system features and to select games and optionally other content.

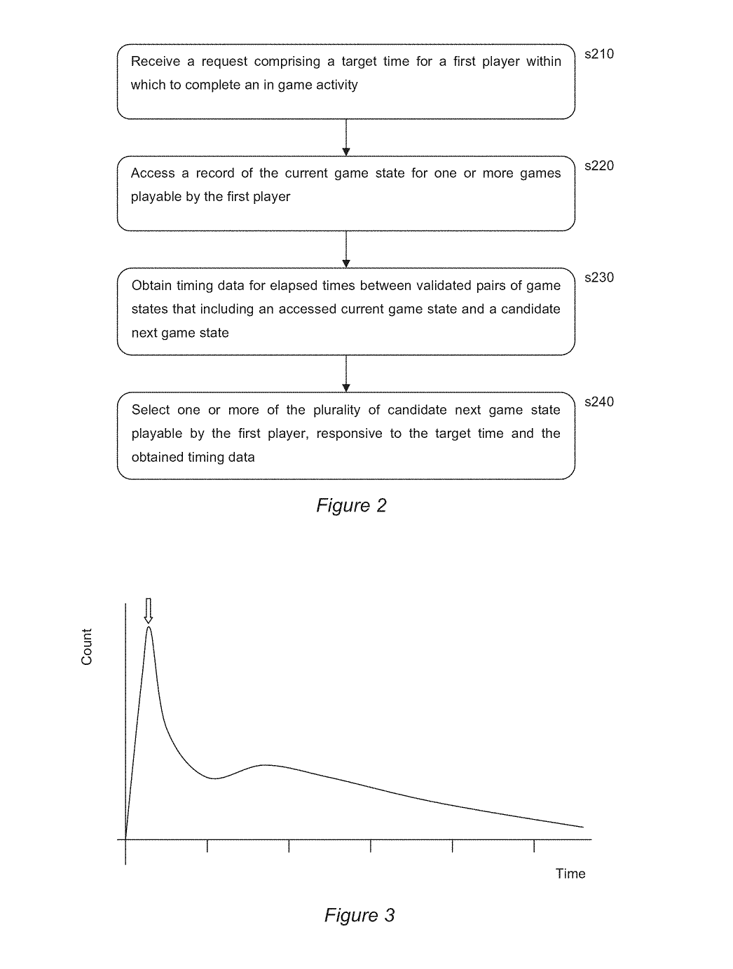

Turning now to FIG. 2, a videogame activity search apparatus such as a Sony® PlayStation 4® entertainment device may operate under suitable software instruction to implement a method of searching for videogame activities.

The search is predicated on finding an in-game activity, from amongst a plurality of games playable by the first player, that may be realistically completed within a time stipulated by the user. This helps players with limited available time to get the most out of their gameplay by effectively enabling them to ask the apparatus to tell them which games they could start/resume playing now, in order to reach a distinct goal or in-game state within the limited time they have available for playing.

To give a specific example, a user may only have 25 minutes available, and select an ‘activity search’ interface via the UI of the apparatus. This activity search interface then provides a means by which the user can set 25 minutes as a target time for play. In response, the apparatus lists one or more games from a plurality of playable games where, given the current state of the game (e.g., the last save), a specific goal could be achieved within 25 minutes. In some cases, one game may have several goals that could be achieved within this time, and so may be listed more than once. A user can then click on one of the suggested games and proceed to play.

Accordingly, in an embodiment of the present invention the method comprises the following steps.

A first step 210 comprises receiving a request comprising a target time for a first player within which to complete an in game activity. As noted above, the target time may be input by the user via a user interface, such as for example a drop-down menu or virtual rotatable tumbler with a selection of times on it, such as 5, 10, 15, 20, 25, 30, 40, 50, 60, 90 minutes, or a pair of drop-down menus or virtual rotatable tumblers with digits provided, to enable the user to define an arbitrary period of time, for example up to 99 minutes.

The request may then be local to the videogame apparatus through which the user interacts if this is acting as the search apparatus, or may be relayed to a remote server acting as the search apparatus via a network.

A second step 220 of the method comprises accessing a record of the current game state for one or more games playable by the first player.

The current game state for a videogame can be obtained from a save file created by that game, which is typically available on a local storage of the videogame apparatus, such as HDD 37. However it is also commonplace for games associated with user accounts to have safe files mirrored to a remote server (e.g. so-called ‘cloud saves’). Similarly for streaming services where the games are run remotely and streamed to a client device, the game save may reside on the remote server. Hence the current game state for a given game may be available on a local videogame apparatus and/or a remote server. It will be appreciated that as long as the game state can be accessed, the precise location is not essential. Where a game has created multiple save files, then the most recent file, or a file identified as a ‘current’ or ‘continue from here’ save file (for example, a file created when exiting the game) may be used as the source for the current game state.

Typically the game state of a game will identify for example some or all of: what level the user is currently on within the game, what save point the game was saved at (if fixed save points are used), the players in-game location, what levels are currently available to the user, what quests/challenges are currently available to the user, and the like.

This information may be extracted from a save file using information provided by the games developer or publisher (for example relating to the location of variables or descriptors for levels, open quests, save points and the like), or may be extracted from a data structure included within the save file that is specifically provided for the purposes of the present technique.

A third step 230 of the method comprises obtaining timing data for elapsed times between validated pairs of game states that includes an accessed current game state and a candidate next game state.

Examples of elapsed times between two game states include the time between two fixed save points, the time to begin and complete a quest, the time to engage and defeat a boss, the time to play a round of a multiplayer game in a particular play mode, the time to level up a character from their current level, the time to reach a key point within the game environment from their current position, and the like.

The timing data for these elapsed times may be obtained from a database, look up table or similar held locally and/or at a remote server. Hence for a given current state, one or more candidate next game states may be associated with it, together with a respective elapsed time. Only states that are associated in this way can be considered a validated pair of game states, for which timing data is obtainable. Hence a validated pair of game states may be considered to be a pair of game states with which timing data has been associated, typically in the form of progression from a first game state to a second game state.

It will be appreciated that a current state may comprise several different game state components that may separately be associated with respective candidate game state components. Hence for example in the role-playing game, the user may have unlocked several quests. Consequently the time to complete each of these quests may be obtainable. Similarly, in a racing game where completion of the preceding race track unlocks the next race track, then the time to complete each unlocked racetrack, including the next race track, may be obtainable.

In an embodiment of the present invention, the timing data for elapsed times between a validated pair of game states is provided by a provider of the respective game, such as for example the developer or publisher of the game. This data may be based upon the providers experience or expectations, or may be empirically derived using one or more of the techniques described herein below.

Alternatively or in addition, the timing data for elapsed times between a validated pair of game states is based on timing data collected from a subset of other players. Hence for example data may be obtained from play-testers used by the developer or publisher of the game, and/or may be obtained from conventional players of the game, who for example have progressed from the first player's current state to the candidate next state within a game.

The elapsed time taken for this subset of players to progress from one state to another is of course likely to vary considerably. To a first approximation, the timing data for the candidate next state may be the average of the elapsed times for this subset of other players.

However, given that the player is searching for activities due to a time constraint, it can be assumed that they are likely to play the game in a focused, goal driven and relatively rapid manner. As a result, to a second approximation the subset of other players comprises a subset of a predetermined percentage of other players having the fastest elapsed times. This serves to bias the average towards a faster gaming style, and may therefore bring the achievement of candidate next game states to within the target time. It also serves to avoid statistical outliers such as players who begin a game and then disengage for long periods, who might otherwise significantly skew the averages.

The predetermined percentage may be determined empirically to provide a bias that results in a realistic elapsed time. Hence for example if the average time for the fastest 50% of players is less than or equal to the target time, then this may provide an enjoyable and achievable activity for the first player, whereas if only the average time for the fastest 5% of players is less than or equal to the target time, then this is likely to be an unachievable activity for the first player, and may result in frustration. Consequently typical values for the predetermined percentage of fastest other players may be 25%, 33%, 50%, 66%, or 75%, with higher percentages being more inclusive of players with less ability, but reducing the number of candidate next game states that will be less than or equal to the target time. Optionally the first player could specify an upper degree of difficulty that could be used to select a corresponding predetermined percentage, with a higher degree of difficulty corresponding to a smaller value for the predetermined percentage.

Alternatively or in addition, the subset of other players may comprise a subset of other players having an elapsed time up to a predetermined multiple of the target time. Notably, unlike the previously described subset where the elapsed time is derived from the average times of other players, in this case the elapsed time is ultimately derived from the target time, because this is used to select the subset of other players.

Hence in this case the subset of players is those who achieved the candidate next state within a period of time similar to the first player's target time. The predetermined multiple is typically one of 1.0×, 1.1×, . . . 1.9×, 2.0×. Whilst a higher multiple may be considered, clearly the average of such a subset of players is more likely to be greater than the target time, making greater multiples unappealing. A typical multiple value is likely to be between 1.5× and 2.0×, typically resulting in an average close to the target time.

However it will be appreciated that this subset of players is selected based on the first player's target time, rather than because they are necessarily representative of elapsed times for achieving the candidate next state. Hence optionally the subset is not included if represents less than a threshold percentage of all players having an elapsed time. This echoes the previous technique, where it was noted that for example if only 5% of other players achieve a given time, then the activity is unlikely to be achievable by the first player. Hence by requiring that a threshold percentage of all players have achieved the candidate next game state within the predetermined multiple of the target time, this provides a corresponding percentage chance that the first player can similarly achieve candidate next game state. For example a threshold percentage may be 25%, 33%, 50%, 66%, or 75%, with higher percentages being more inclusive of players with less ability, but reducing the number of candidate next game states that will qualify.

However, for some game states, the reverse may be true; referring now to FIG. 3 as an illustrative example, this chart represents a count of player-completions of a quest on the y-axis, and time on a roughly logarithmic scale on the x-axis, such that the respective indices on the x-axis correspond to one hour, one day, one week, one month, and one year. In games such as role-playing games, a player may instigate a number of quests simply by talking to an in game character or visiting in game location. However not all players will immediately begin that quest, for example because they are in the middle of another quest. The chart in FIG. 3 illustrates the resulting completion rate as a function of time for players of the game. As can be seen in this example, there is a peak in the region of 15-30 minutes (indicated by an arrow), which represents those players who immediately began and completed the quest when they first instigated it; however there is then a long tail of players who completed the quest over comparatively arbitrary timeframes corresponding to when they arbitrarily chose to explore that quest (the graph shows a secondary peak, caused by players starting the quest the next day). Hence particularly in the case of a game with multiple candidate next game states, optionally the threshold percentage may be low, such as for example 5%, or alternatively an initial peak in the completion of a candidate next game state may be searched for, and this may be taken as the median completion time for a player who immediately embarks on that particular candidate next game state.

Hence it will be appreciated more generally that alternatively or in addition to any of the above described techniques, the timing data may be obtained from a histogram of players' elapsed times, of which a first peak is representative of the median elapsed time of other players to achieve the candidate next game state. In other words, elapsed time histograms may be used to characterise the transition between a validated pair of game states within the database, and the first peak within the histogram (or a smoothed version thereof) may be used as the median elapsed time for players to transition from the first game state to the second game state of the pair. In this case, the histogram may be compiled using data from all players, or any one or more of the subsets of other players described herein.

As another possible subset, alternatively or in addition to one or more of the above subsets of other players relating to a predetermined percentage of fastest players, or players who achieve the candidate next game state within a predetermined multiple of the first players target time, the subset may comprise other players having an elapsed time for one or more other validated pairs of game states that is within a predetermined tolerance threshold of an elapsed time for the first player for the same validated pair of game states.

In other words, the first player's own time to previously complete the progression from one game state to another (for example, the time to progress from a previous save point to the current save point, or the time to complete a particular quest) may be used as a basis for comparison to identify other players with a similar elapsed time for that validated pair of game states. The elapsed times of these identified other players for achieving a candidate next game state may therefore be particularly good predictors of how long the first player would take to similarly achieve the candidate next game state. Again, an average value for the elapsed time from these identified other players may be used.

It will be appreciated that this corpus of identified other players may then be used as the basis for any of the above techniques, so that for example as described previously a predetermined fastest percentage of the identified players may be used to form an average elapsed time biased towards fast/focused play, or may be used to form or filter an elapsed-time histogram from which to extract a peak time.

It will be appreciated that for some validated pairs of game states, the first player's current game state can map exactly onto the first game state of the pair; for example when the validated pair of game states correspond to fixed save points, then the first player's current game save point will correspond exactly to one of the game states in the database. Similarly where the game state relates to which levels or racetracks are unlocked within a game, then the correspondence can be exact. However for other game states, the match may not be exact.

Hence for example a validated pair of game states may correspond to progressing between two key points in a game, which may for example correspond to physical positions within the game. In this case, the first player may have last saved the game at an arbitrary position within the game world. The search apparatus may then calculate whether the first player's saved position is within a predetermined threshold distance of a key point within the game, and if so then assume that the key point is sufficiently representative of the player's actual position to form the basis for obtaining a realistic elapsed time to reach the other key point from the database.

Hence more generally, a first player's current game state can be treated as if it corresponds to a game state of a validated pair of game states if the difference between these states is within a predetermined threshold tolerance.

A fourth step s240 of the method comprises selecting one or more of the plurality of candidate next game states playable by the first player, responsive to the target time and the obtained timing data.

As described above, the obtained timing data may correspond to biased or unbiased averages of elapsed times, or peak elapsed times in a histogram, for a subset of players transitioning between a game state similar to (within a tolerance) or the same as the first player's current game state, and a candidate next game state.

Hence at its simplest, a candidate next game state may be selected if the elapsed time indicated by the obtained timing data is the same as or less than the target time.

Where more than one candidate next game state meets this criterion and is selected, the first player may be provided with the option to choose from among the selected next game states. As noted previously herein, the selected next game states may come from one or more games, and depending on the game, one game may be associated with a plurality of candidate next game states and may result in a plurality of selected next game states.

The above simple criterion introduces a possibility that where for example the user stipulates they have 45 minutes to play, then an activity that only takes five minutes to complete may be selected because it is shorter. However, this is unlikely to satisfy the player.

Hence alternatively a candidate next game state may be selected if the elapsed time indicated by the obtained timing data is within a threshold percentage range of the target time. Example percentage ranges may include 75% to 100%, 90% to 100%, 80% to 110% and the like. In these cases, achieving the selected next game state(s) are likely to occupy most or all of the user's specified target time, providing a satisfactory experience for the user.

It will be appreciated that a user may be able to play a significant number of games, and as a result the number of candidate next game states that meet such criteria could become very large. Consequently candidate next game states could be ranked according to how close the timing data matches the target time (or threshold range), and the top N ranked candidate next game states could be provided for the user to choose from, where N is a predetermined number such as ten (by way of a non-limiting example).

As an optional refinement, a maximum of M candidate next game states could be ranked from a given game, for example to prevent one game that has a multitude of levels of similar length from fully populating the top N ranking. In this case M may be significantly smaller than N, such as by way of a nonlimiting example 2 or 3.

Such a ranking may also comprise one or more weighting factors responsive to other aspects of a playable game, for example in order to promote games that were recently played by the first player, or games that have been frequently played by the first player. Similarly other aspects of gameplay may be factored into a weighting scheme, such as how close the candidate next game state is to the end of the associated game, or whether the selected next game state is associated with a trophy or other reward.

The ranking may also take account of practical factors unrelated to the game play itself or to the candidate next game states. For example, videogame consoles regularly check whether a patch is required for a game in order to play; if it is detected that a candidate next game state corresponds to a game that requires a patch to be downloaded first, then the candidate next game state may be excluded from the rankings (for example if the download and installation time is greater than a predetermined threshold), or adversely weighted or have an estimated download time for the patch added to the elapsed time data (which would also serve to change its ranking).

It will be appreciated that if download and installation times are added to the estimated elapsed time for candidate next game states, then optionally in conjunction with a threshold for a maximum download and/or installation time, validated pairs of game states for the start of a completely new game and a first achieved outcome within that game may also be considered. This allows the inclusion of games that have been downloaded by the user but not yet installed or initialised, and/or or the inclusion of games that have already been purchased by the user but not yet downloaded and installed, and/or the inclusion of games that the user could acquire for download, such as for example games made available for a limited trial by a player.

Similarly, the time taken to run a game and load the save game comprising the first players current game state may vary significantly between games, and so may optionally be added to the obtained timing data when ranking selected next game states. The duration of this game configuration period may be measured locally at the videogame console (since the time taken is likely to depend on local factors such as disk fragmentation, processor speed, available memory and the like).

Hence more generally, the step of selecting one or more of the candidate next game states playable by the first player, responsive to the target time and the obtained timing data, may optionally be further responsive to a predicted game configuration period required to launch a respective game in the respective current game state, and optionally further comprises a predicted period of time for downloading and installing required game code (such as for example a patch or DLC, or a game download).

Hence in summary the step of selecting one or more of a plurality of candidate next game states may comprise ranking the selected next game state responsive to one or more selected from the list consisting of:
i. how recently the first player played the associated game;
ii. the total time that the first player has played the associated game;
iii. how close the selected next game state is to the end of the associated game;
iv. whether the selected next game state is associated with a reward; and
v. whether the associated game does not require data to be downloaded before starting.

It will be appreciated that in principle at least some the above described techniques may optionally employ any suitable machine learning technique. Hence for example whilst validated game states may be provided by the producer of a game, alternatively or in addition the identification of significant game states may be achieved using suitable machine learning, for example identifying location clusters where a plurality of users regularly save, or identifying common transitions between states that reflect unanticipated user behaviour (for example, a significant proportion of users doubling back to a previous location because although it does not progress the story of the game, the previous location is a rich source of raw materials). Similarly suitable machine learning may be used to identify what games to select candidate next game states from, for example based on what candidate next game states the first player has previously chosen in response to a particular target time, and/or at a particular time of day or day of the week, and optionally based on what candidate next game states other players have chosen in response to similar circumstances and/or game catalogues. Also similarly suitable machine learning may be used to rank selected next game states, or provide a weighting that can be used within such ranking, for example based upon preferences previously identified by the first player or inferred from their play history, and a representation of the selected next game state and/or associated game corresponding to those preferences.

It will be appreciated that the above techniques may be carried out on conventional hardware, such as a videogame console, PC or streaming server running a game, or a server of a service provider administering an account of the first player, or a combination of the two, if the conventional harbour is suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Hence in an embodiment of the present invention, a videogame activity search apparatus (such as for example a Sony PlayStation 4 (10) operating under suitable software instruction) comprises a reception processor (such as CPU 20A operating in conjunction with an input port such as an Ethernet® port (32), Wi-Fi® port (34) or Bluetooth® port (33)), adapted (for example by suitable software instruction) to receive a request comprising a target time for a first player within which to complete an in game activity. The apparatus also comprises a record access processor (such as CPU 20A) adapted (for example by suitable software instruction) to access a record of the current game state for one or more games playable by the first player. As noted previously herein, these game states may be held locally in storage such as a hard drive (37), and/or may be accessible from a remote server via a network connection such as an Ethernet® port (32). The apparatus also comprises a timing data access processor (such as CPU 20A) adapted (for example by suitable software instruction) to obtain timing data for elapsed times between validated pairs of game states that includes an accessed current game state and a candidate next game state. Again as noted herein, this timing data may be held in any suitable data structure, such as a database, and may be local to the apparatus and/or accessible from a remote server via a network. The apparatus 10 also comprises a selection processor (such as CPU 20A) adapted (for example by suitable software instruction) to select one or more of the plurality of candidate next game states playable by the first player, responsive to the target time and the obtained timing data. As noted previously herein, the selection processor may select next game states, according to a number of criteria, and rank them whilst optionally employing one or more weights.

It will be apparent to a person skilled in the art that variations in the above apparatus corresponding to various embodiments of the method as described and claimed herein are also considered within the scope of the present invention, including but not limited to the timing data for elapsed times between a validated pair of game states being based on timing data collected from a subset of other players, and being the selection processor is adapted to select one or more the plurality of next game states playable by the first player further responsive to a predicted game configuration period required to launch a respective game in the respective current game state.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of searching for videogame activities, comprising the steps of:
receiving a request comprising a target time for a first player within which to complete an in game activity;
accessing a record of the current game state for one or more games playable by the first player;
obtaining timing data for elapsed times between validated pairs of game states that includes an accessed current game state and a candidate next game state; and
selecting one or more of the plurality of candidate next game states playable by the first player, responsive to the target time and the obtained timing data.

2. The method of claim 1, in which the timing data for elapsed times between a validated pair of game states is based on timing data collected from a subset of other players.

3. The method of claim 2, in which the subset of other players comprises a subset of a predetermined percentage of other players having the fastest elapsed times.

4. The method of claim 2, in which the subset of other players comprises a subset of players having an elapsed time up to a predetermined multiple of the target time.

5. The method of claim 4, in which the subset is not included if it represents less than a threshold percentage of all players having an elapsed time.

6. The method of claim 2, in which the timing data is obtained from an elapsed time histogram of which a first peak is representative of the median elapsed time of other players.

7. The method of claim 2 in which the subset comprises other players having an elapsed time for one or more other validated pairs of game states that is within a predetermined tolerance threshold of an elapsed time for the first player for the same validated pair of game states.

8. The method of claim 1, in which the timing data for elapsed times between a validated pair of game states is provided by a provider of a respective game.

9. The method of claim 1, in which the step of selecting one or more of the candidate next game states playable by the first player, responsive to the target time and the obtained timing data, is further responsive to a predicted game configuration period required to launch a respective game in the respective current game state.

10. The method of claim 9, in which the predicted game configuration period comprises a predicted period of time for downloading and installing required game code.

11. The method of claim 1, in which the step of selecting one or more of a plurality of candidate next game states comprises the step of:
ranking the selected next game states responsive to one or more selected from the list consisting of:
i. how recently the first player played the associated game;
ii. the total time that the first player has played the associated game;
iii. how close the selected next game state is to the end of the associated game;
iv. whether the selected next game state is associated with a reward; and
v. whether the associated game does not require data to be downloaded before starting.

12. A non-transitory, computer readable storage medium having stored thereon computer executable instructions, which when executed by a computer system, cause the computer system to carry out actions, comprising:
receiving a request comprising a target time for a first player within which to complete an in game activity;
accessing a record of the current game state for one or more games playable by the first player;
obtaining timing data for elapsed times between validated pairs of game states that includes an accessed current game state and a candidate next game state; and
selecting one or more of the plurality of candidate next game states playable by the first player, responsive to the target time and the obtained timing data.

13. A videogame activity search apparatus, comprising:
a reception processor adapted to receive a request comprising a target time for a first player within which to complete an in game activity;
a record access processor adapted to access a record of the current game state for one or more games playable by the first player;
a timing data access processor adapted to obtain timing data for elapsed times between validated pairs of game states that includes an accessed current game state and a candidate next game state; and
a selection processor adapted to select one or more of the plurality of candidate next game states playable by the first player, responsive to the target time and the obtained timing data.

14. The apparatus of claim 13, in which: the timing data for elapsed times between a validated pair of game states are based on timing data collected from a subset of other players.

15. The apparatus of claim 13, in which the selection processor is adapted to select one or more the plurality of next game states playable by the first player further responsive to a predicted game configuration period required to launch a respective game in the respective current game state.
